(19) United States
(12) Patent Application Publication
(10) Pub. No.: US 2019/0310667 A1
(43) Pub. Date: Oct. 10, 2019

(54) SYSTEM FOR PROVIDING THERMOSTAT CONFIGURATION GUIDANCE

(71) Applicant: ENGIE NORTH AMERICA, Houston, TX (US)

(72) Inventors: Mark BROWN, Houston, TX (US); Joel ELKINS, Houston, TX (US); Jeremy LO, Houston, TX (US)

(73) Assignee: ENGIE NORTH AMERICA, Houston, TX (US)

(21) Appl. No.: 16/463,291

(22) PCT Filed: Nov. 21, 2017
(86) PCT No.: PCT/US2017/062843

§ 371 Date: May 22, 2019

Related U.S. Application Data
(60) Provisional application No. 62/425,458, filed on Nov. 22, 2016.
(60) Provisional application No. 62/568,731, filed on Oct. 5, 2017.

(51) Int. Cl. G05D 23/19; G06Q 30/02; G06Q 50/06

(52) U.S. Cl. CPC G05D 23/1917; G01W 1/10; G06Q 50/06; G06Q 30/0283

(57) ABSTRACT

The disclosed technology relates to log file processing techniques for providing thermostat configuration guidance. A system may be configured to receive, from a load forecast engine, a plurality of load forecasts associated with a thermostat set point schedule and receive, from a user device, a change in the thermostat set point schedule. The system generates a hybrid load forecast by selecting a portion of a first load forecast in the plurality of load forecasts and a portion of a second load forecast in the plurality of the load forecasts based on the change in the change in the thermostat set point schedule. The system calculates a cost for the change in the thermostat set point schedule based on the hybrid load forecast and a fee schedule and provides the user device with the cost for the change in the thermostat set point schedule.

### CROSS-REFERENCE TO RELATED APPLICATIONS

The present application claims the benefit of priority to U.S. Provisional Application Ser. No. 62/425,458, filed Nov. 22, 2016, entitled “SYSTEM AND METHOD OF MODELING AND PREDICTING INTERIOR TEMPERATURE RESPONSES WITHIN A BUILDING TO AIR CONDITIONING AND CREATING DIGITAL SIGNATURES OF APPLIANCES” and U.S. Provisional Application Ser. No. 62/568,731, filed Oct. 5, 2017, entitled “SYSTEM FOR PROVIDING THERMOSTAT CONFIGURATION GUIDANCE,” which are hereby incorporated by reference in their entireties.

### TECHNICAL FIELD

The subject matter of this disclosure relates in general to the field of building energy usage, and more specifically to providing thermostat configuration guidance.

### BACKGROUND

Energy consumers typically are unable to accurately determine how much energy they use and/or how large a utility bill will be in a given billing period. For most customers, heating, ventilation, and air conditioning (HVAC) systems will account for a large portion of their energy usage and corresponding utility bill. Although customers usually have quite a bit of control to manage energy usage and thus manage the cost of a utility, they lack of knowledge about how a building consumes energy or how certain actions affect energy usage and utility bills. This uncertainty may lead to difficulties in budgeting, an unhappy customer if the customer receives a higher than expected utility bill, and possibly inefficient use of resources.

### BRIEF DESCRIPTION OF THE FIGURES

Implementations of the present technology will now be described, by way of example only, with reference to the attached figures, wherein:

FIG. 1 is an example of a building environment for implementing the disclosed subject matter;

FIG. 2 is an example of a network environment for implementing the disclosed subject matter;

FIGS. 3A and 3B are examples of user interfaces, in accordance with various aspects of the disclosed subject matter;

FIGS. 4A-4E are examples of additional user interfaces, in accordance with various aspects of the disclosed subject matter;

FIG. 5 illustrates an example method for calculating a predicted cost of a climate control device (e.g., a thermostat) configuration, in accordance with various aspects of the disclosed subject matter;

FIG. 6 illustrates an example method for generating a climate control device configuration based on a target cost, in accordance with various aspects of the disclosed subject matter;

FIG. 7 illustrates an example method for calculating an estimated cost of a change in a thermostat set point schedule, in accordance with various aspects of the disclosed subject matter;

FIG. 8 is a graph illustrating a number of load forecasts associated with a set point schedule, in accordance with various aspects of the subject technology;

FIG. 9 is a graph illustrating a hybrid load forecast associated with a change in a thermostat set point schedule, in accordance with various aspects of the subject technology;

FIG. 10 illustrates an example method of dispatching events to smart thermostats, in accordance with various aspects of the subject technology;

FIG. 11 illustrates an example method of determining appliance inefficiencies through energy signatures; and

FIGS. 12A and 12B illustrate example system, in accordance with various aspects of the disclosed subject matter.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It is difficult for a utility customer to have a good understanding of how much energy (e.g., electricity, natural gas, oil, propane, renewable energy, etc.) they consume in a given period or the corresponding utility bill will be until the energy consumer receives the utility bill. This uncertainty may lead to difficulties in budgeting and/or an unhappy customer if the customer receives a higher than expected utility bill.

There are many actions a energy consumer may take to manage energy usage and, as a result, manage the cost of a utility bill. For example, air conditioning can be considered to encompass both heating and cooling and is typically the largest aspect of energy consumption in both residential and commercial buildings. As such, certain savings can be accomplished by variously operating the air conditioning of a building. However, the customer may still not know how the current air conditioning settings or changing the operation of the air conditioning will affect the bill.

Aspects of the subject technology relate to systems and methods configured to determine a relationship between a configuration for a climate control device (e.g., a thermostat, etc.) associated energy usage and a cost. The relationship between the configuration, the energy usage and the cost can be generated based on, for example, an energy usage history, a rate schedule specifying the cost of energy over time, data about user preferences or tolerances, and data about the thermal efficiency of the building. Based on one or more relationships, the system can calculate a predicted cost of a climate control device (e.g., a thermostat) configuration. The predicted cost may be provided to a user to notify the user about an expected bill amount and/or enable the user to make more informed decisions on how to configure a climate control device and the impacts of the configuration. According to some aspects, the system can generate a climate control device configuration based on a target cost.

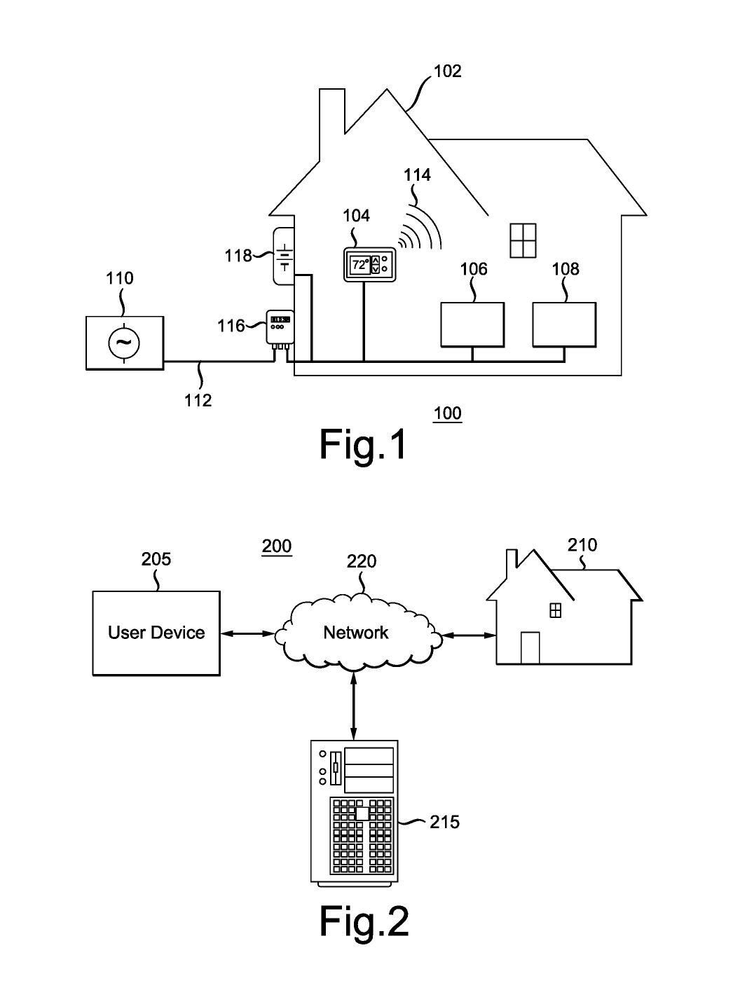

FIG. 1 is an example of a building environment 100 for implementing the disclosed subject matter. Building environment 100 can include building 102 (e.g., single family house, multi-family house, townhouse, apartment, condo, commercial building, factory, etc.) configured with one or more climate control devices 104. The climate control device 104 can be thermostats, including smart thermostats, for example, devices used in home automation for controlling heating or air conditioner of a building and being connected to a community network. The climate control device 104 can be communicatively coupled with a heating system (e.g., furnace, boiler, heat pump, fire place, space heater, radiant floor heater, generator, energy storage, etc.) and a cooling system (e.g., air conditioners, evaporative coolers, night breeze, thermal energy storage, etc.). In some examples, the heating and cooling systems can be heating, ventilation, and air conditioning (HVAC) technologies.

A smart thermostat (and/or meter 116) can also be communicatively coupled to other appliances or devices (e.g., refrigerator, dishwasher, pool pumps, lighting, batteries, solar panels, wind turbines, washer and dryers, televisions, entertainment centers, etc.). In some examples, smart thermostat (and/or meter 116) can create digital profiles/signatures for each connected appliance or device. A smart thermostat can also be equipped with (two) 2 wireless transmitter (e.g. Wi-Fi, Bluetooth, short range wireless, etc.) for communicating with the cooling and heating systems, meter 116, or any other system or appliance in environment 100. A smart thermostat can be communicatively coupled (e.g., wired or wireless) to meter 116 (e.g., smart meter, etc.). Meter 116 can determine the electrical usage (from power source 110) of building 102. Meter 116 can be coupled (e.g., 112) to an external power source 110. In some examples, building 102 can include energy storage solution 118 (e.g., battery storage, etc.). Energy storage solution 118 can store power from the external power source 110 (e.g., during non-peak times), solar panels (not shown), wind turbines (not shown), or any other generator of electricity.

FIG. 2 is an example of a network environment 200 for implementing the disclosed subject matter. The network environment 200 includes a user device 205, a building environment 210, and an energy advisor system 215, which can be configured to communicate with one another over a network 220. The network 220 can include any appropriate network, including an intranet, the Internet, a cellular network, a local area network, a wide area network, short range wireless or any other such network, or combination thereof. The network can include wired or wireless connections, and combinations thereof.

The building environment 210 in FIG. 2 can be an environment similar to the building environment 100 illustrated in FIG. 1 and include, for example, a meter and a climate control device communicatively coupled with a heating system and/or a cooling system. The user device 205 can be any device that a user can use to interact with the energy advisor system 215. The user device 205 can be a computer, a mobile device (e.g., a smart phone or tablet), a set-top box, a smart appliance, or the like and can be located inside the building environment 210 or be external to the building environment 210. In some aspects, the user device 205 can be collocated with a smart meter or smart thermostat device.

Similarly, the energy advisor system 215 can be internal or external to the building environment and be collocated with a smart meter or smart thermostat device. However, in some aspects of the subject technology, the energy advisor system 215 can be implemented as a cloud platform that includes one or more server machines (e.g., a web server, an application server, one or more databases, etc.). According to various aspects, the energy advisor system 215 is configured to determine a relationship between a configuration for a climate control device (e.g., a thermostat), energy usage and a cost, calculate a predicted cost of a climate control device configuration, and notify the user about the predicted cost. The energy advisor system 215 can also, or alternatively, obtain a target cost for a user based on a user profile or input received from the user and generate a climate control device configuration based on the target cost.

According to various aspects, the relationship between the configuration for the climate control device, energy usage and a cost can be determined based on, for example, an energy usage history for the building, a rate schedule for the cost of energy, data about user comfort preferences or tolerances, data about the thermal efficiency of the building, etc. The energy usage history can include time-series data about an amount of energy used by the building over time. In some implementations, utilities charge different amounts for units of energy based on the time of day, day of week, or demand (expected or actual) for that energy across the energy distribution network. This information can be reflected in the rate schedule, which includes data specifying the cost of energy over time. The data about user comfort preferences or tolerances can be an optimal temperature for the building or a range of acceptable or tolerable temperatures. Although various aspects of the subject technology are discussed with respect to temperature, other conditions such as, humidity, light, wind, external weather conditions, etc., are also contemplated.

The information used to determine the relationship can be obtained via the network 220. For example, the energy usage history for the building and a rate schedule can be obtained from the utility company. In another variation, however, the energy usage history can be obtained over time directly from a smart meter for the building. The data about user comfort preferences or tolerances can be obtained from the user via user device 205, from a user profile stored by the energy advisor system 215 or obtained from a third-party. The data about the thermal efficiency of the building can be obtained from a third-party or generated by the energy advisor system 215.

According to various aspects of the subject technology, a diagnostic tool or procedure can be used by the energy advisor system 215 to determine the thermal efficiency of a building. For example, every building has a unique set of characteristics that effect interior temperature reactive behavior (e.g., rates of interior temperature change, etc.) in response to a building's air conditioning system and/or to outside conditions (e.g., temperature, wind, precipitation, humidity, shade, etc.). For example, two temperature behavioral aspects include (1) at what rate(s) does the interior temperature of the building change when the air conditioning is running, and (2) at what rate(s) does the interior temperature of the building change when the air conditioning is not running (both in response to outside conditions).

Certain characteristics of the building that impact these rates of interior temperature change include, for example, square footage, number of stories, layout, portion underground (e.g., basements), directional orientation (facing North, South, East or West), roofing type, insulation factor, attic ventilation, exterior sheathing (brick, stucco, wood, concrete, etc.), the air conditioning's efficiency rating/capability, window U-Factor, window solar heat gain coefficient, or window and building air leakage. Transient external or environmental characteristics can also have influence. For example, temperature, humidity, cloud coverage, shade (e.g., by trees or buildings), and precipitation may affect the rates of interior temperature change. For example, the outside atmospheric temperature, which is rarely static, typically has the greatest impact on how fast a particular building can cool off or warm up based on whether the air conditioning is running or not running.

Based on these characteristics, the measured internal temperatures of the building over time, the measured external conditions over time, and a schedule of when an air conditioning system was on or off, the energy advisor system 215 can generate a thermodynamic model or profile of the building that specifies the building's thermal efficiency. According to other aspects, the energy advisor system 215 can generate a thermal efficiency score for the building.

In order to gather data useful in modeling the reactive behavior a particular building's interior temperature as described above, the presently disclosed diagnostic tool or procedure is utilized. The diagnostic tool/procedure can obtain at least an initial body of data by observing the building over a set period of time can be used in the future to model how the interior temperature of a building will react under the initial body various conditions to the running versus stopping air conditioning. In a basic aspect, a remotely controllable smart thermostat is used at the building to turn the air conditioning on and off. Optionally, the thermostat can also be used to report, in real time, corresponding interior temperatures occurring during a period when the air conditioning is running or a period when the air conditioning is turned off. The interior temperature can also be reported by separate means, and can be measured either proximate to, or remotely from the location of the thermostat inside the building. An iterative process is employed in which the air conditioning is alternately run and turned off for certain periods. During each period of either the air conditioning being on or off, real time, elapsed interior temperatures of the building are measured and recorded either locally or remotely. The length of any given period of on or off air conditioning operation can be based on either a prescribed amount of time or a particular interior temperature change being achieved. In either case, the operational strategy can be determined remotely and implemented via the smart thermostat at the building.

In some instances a building owner can be given an incentive to permit the installation of such a smart thermostat in their building, by the party (e.g., energy company) desiring the information and control of the thermostat. As an example, a smart thermostat can be offered free-of-charge, or at a discount for allowing its installation in a building of interest and as an incentive for the owner to permit administrative control of the building's air-conditioning systems utilizing the manipulation processes defined below. Generally, priority for free or discounted smart thermostats can be given for buildings identified as having characteristics that will provide particularly desired diagnostic information. Relatedly, a building can be prioritized for receipt of a smart thermostat if it has certain characteristics that will lend to advantageous air-conditioning control in the future. For example, a building may be identified as being exceptionally thermally efficient and therefore its air-conditioning can be turned off when it is advantageous to reduce energy consumption for a period of time with acceptable impact on occupants. This type of thermal load shifting may be affected for conservation or economic purposes as herein described. Examples of factors that can be considered include geographic location, building/house profile, building thermal signature, energy delivery or sales company, historical energy usage, energy saving equipment, or appliances building specification and the like. In other examples, the smart thermostats can be provided based on customer contract commitments to particular electricity providers, such as, multi-year contracts. In other examples, the smart thermostat(s) can be provided randomly or semi-randomly.

Regarding smart thermostat placement in buildings that are housing occupants, if the building is occupied while the diagnostic procedures are being implemented, occupant comfort can be taken into consideration. To that end, the temperature will have to be maintained within an acceptable tolerance of the preferred temperature of the occupants. The temperatures can be set to a default temperature (e.g., 70° F., etc.) and can be configured by a user. For this reason, the length of each period of on or off air conditioning operation will likely be required to be relatively short, at least for one of the operational states. For instance, on a hot summer day, the air conditioning cannot be non-operational for very long periods of time in order to prevent the building from exceeding the preferred temperature. On the other hand, the air conditioning will have to be run for comparatively longer periods of time as the building's interior will cool down slowly while the air conditioning is running than it warmed up while the air conditioning was non-operational.

In a further aspect, the diagnostic tool is enabled to determine whether occupants are present, or not in the building (e.g. via sensors, etc.). Alternatively, certain periods of time can be prescribed for building occupation when the air conditioning of the building are controlled for occupant comfort. This is important because when it is determined that the building is vacant, wider ranges of diagnostic temperature control can be implemented and corresponding data gathered. For instance, with the air conditioning off, the building can be allowed to heat up to a higher temperature than would be comfortable for occupants (e.g., exceed preferred temperature); subsequently, the air conditioning is activated and the interior temperature behavior is tracked up to, and across the occupant temperature comfort zone. In this manner, information about how early in a day and at what temperature does the air conditioning of a particular building must be activated for the building to be suitably comfortable for occupation at a prescribed time is gathered. For instance, in the summer, at what time in the day does the air conditioning have to be turned on to have the building sufficiently cool by the first occupants' arrival. The implementation can vary (e.g., how early the air condition is turned on, what temperature, and speed, etc.) based on existing atmospheric conditions (e.g., whether known or forecast), such as, outside temperature and precipitation. To facilitate these implementations, it is desirable to run the described diagnostics on interior temperature reactions during similar actual conditions to facilitate their future accurate modeling.

Once a sufficient amount of information or data is gathered regarding actual interior temperature reactions of the building, that information can be utilized to predict similar behavior under similar conditions. Knowing these behaviors, air conditioning control strategies can be implemented in the future in order to manipulate the building's power consumption, while at the same time maintaining occupant comfort within prescribed tolerances.

The diagnostic tool can be “cloud” based with processing, command, and data storage occurring remotely from the building. Communication between the controlling remote servers and the various buildings and their appliances, including the air-conditioning units, can occur at least partially over the Internet. Communication can also be over short range wireless or local network. In this sense, the diagnostic routines, as well as future control strategies derived therefrom occur within the environment of the Internet of Things (IOT). Furthermore, and as will be later described, integrated control strategies for groups of buildings can be implemented, further utilizing the IOT aspects of the subject matter of this disclosure.

Many enhancements to this basic diagnostic process are contemplated. For instance, any one or more of the variable characteristics that affect the interior temperature of the building can also be measured and reported in correspondence with the interior temperature readings being taken inside the building. Examples include one or more real time measurements of the atmospheric temperature(s) outside the building. Another example would be one or more temperature measurements at various locations on the building's exterior surface. For instance, on a sunny day, the roof and exterior surfaces being struck by the sun will significantly impact interior temperature reaction to air conditioning. Real time measurements of humidity inside and outside the building can also be taken as humidity affects not only the rate of interior temperature changes, but also occupant comfort. Static characteristics of the building such as square footage, layout and directional orientation need not be measured, but such known quantities can be used in future air conditioning control strategies to fine tune predicted interior temperature responses.

Certain corresponding qualitative data may also be considered, whether measured or obtained from other sources. For example, the degree of cloud cover or precipitation occurring at any given time can affect interior temperature responses, and can be used in the future to predict interior temperature responses based on forecasts of similar weather conditions provided by third parties.

A related aspect of the information gathering process described above is that as it continues and more information is gathered, even after the initial diagnostic period is over and prescribed control strategies begin to be implemented, modeling of the building's internal temperature reactions becomes more and more accurate, across a wider range of variables and variable values as they are encountered and the related data is collected and processed for future predictions. In some examples this learning can be implemented on a neural network. The neural network can be “trained” with the data to an “autonomous” or “semi-autonomous state that is, the neural network can control the building without interaction form the user.

One example of the presently disclosed diagnostic process for modeling temperature reactiveness of an air conditioned building's interior is embodied in the method described herein that determines a temperature restoration characteristic of the building. In this instance, the situation when the air conditioning is running is modeled. The method comprises (includes, but is not limited to) recording a first initial interior temperature of an air conditioned building occurring at a remotely controllable thermostat in that building. The air conditioning of the building is caused to operate for a temperature-recording period. A plurality of temperature readings are recorded (e.g., during predetermined intervals) relative to elapsed time during the temperature-recording period of air conditioning operation at the remotely controllable thermostat, and based on at least the gathered information, determining a temperature rate of change characteristic of the building during air conditioning operation to be utilized in future air conditioning control strategies of the building.

In a further aspect, a condition capable of influencing the temperature restoration characteristic of the air conditioned building relative to at least one point in time during the temperature-recording period is quantified, and optionally recording a quantified value of the condition capable of influencing the temperature restoration characteristic of the air conditioned building relative to at least one point in time during the temperature-recording period. The quantified condition capable of influencing the temperature restoration characteristic of the air conditioned building can be an atmospheric condition occurring proximate the air conditioned building. As examples, the quantified atmospheric condition occurring proximate the air conditioned building comprises at least one of temperature, humidity, cloud cover, and precipitation, etc.

In a more specific example, the method includes determining and recording an ambient temperature outside the building occurring during at least one point in time during the temperature-recording period. In order to obtain a robust and wide array of data, it is advantageous to iteratively repeat these various steps for each of a plurality of different ambient temperatures outside the building. In some examples, the data, can be put into a neural network for training.

In another aspect, the quantified condition capable of influencing the temperature restoration characteristic of the air conditioned building is a characteristic of the air conditioned building. Examples include, among others, one or more of: (1) square footage, (2) number of stories, (3) portion underground, (4) directional orientation, (5) roofing type, (6) insulation factor, (7) attic ventilation, (8) exterior sheathing, (9) the air conditioning's efficiency rating/capability, (10) window U-factor, (11) window solar heat gain coefficient, (12) window air leakage, (13) building air leakage, and (14) layout.

In another example of the presently disclosed process, a method for determining a temperature retention characteristic of an air conditioned building is described and which takes place during a period when the air conditioning is turned off. One step of the process includes recording a first initial interior temperature of an air conditioned building occurring at a remotely controllable thermostat in the building. Air conditioning of the building is caused to be abstained (turned off) for a temperature-recording period. A plurality of temperature readings are recorded (e.g., at predetermined intervals) relative to elapsed time during the temperature-recording period of air conditioning abstinence at the remotely controllable thermostat, and based on the gathered information, determining a temperature rate of change characteristic of the building during air conditioning abstinence operations to be utilized in future air conditioning control strategies of the building.

Optionally, a contemporaneously occurring ambient temperature is determined outside the building at the time that the first initial interior temperature is recorded. The temperature-recording period can be based upon a predetermined temperature differential occurring relative to the first initial interior temperature. Alternatively, the temperature-recording period can be based upon a predetermined period of time.

The method can include causing a subsequent initial interior temperature of the air conditioned building to be established by the running of the air conditioning unit of the building until the subsequent initial interior temperature is achieved and wherein the subsequent initial interior temperature is either the same or different from the first initial interior temperature.

In another aspect, the method can include causing the first initial interior temperature of the air conditioned building to be established by running the air conditioning unit of the building until the desired first initial interior temperature is achieved, wherein the air conditioning unit is a cooling unit utilized to cool the interior of the building. In this regard, the first initial interior temperature is a temperature within an occupant comfort temperature zone. This first initial interior temperature can be the lowest temperature of the occupant comfort temperature zone.

In yet another aspect, the temperature-recording period extends from the first initial interior temperature setting at the lowest temperature of the occupant comfort temperature zone until the highest temperature of the occupant comfort temperature zone is achieved. In this regard, the occupant comfort temperature zone is determined based on preferences of the occupants of the building.

Another step of the process can include determining a contemporaneously occurring ambient temperature outside the building at the time that the first initial interior temperature is recorded. As an option, a subsequent initial interior temperature of the air conditioned building is caused to be established by the running of the air conditioning unit of the building until the subsequent initial interior temperature is achieved. A plurality of temperature readings are recorded relative to elapsed time during the air conditioning period at the remotely controllable thermostat and a temperature rate of change characteristic of the building is determined during cooling operations to be utilized in future air conditioning control strategies of the building.

In another aspect, the subsequent initial interior temperature is the same as the first initial interior temperature but the ambient temperature occurring outside the building is different from the ambient temperature determined contemporaneously with the first initial interior temperature.

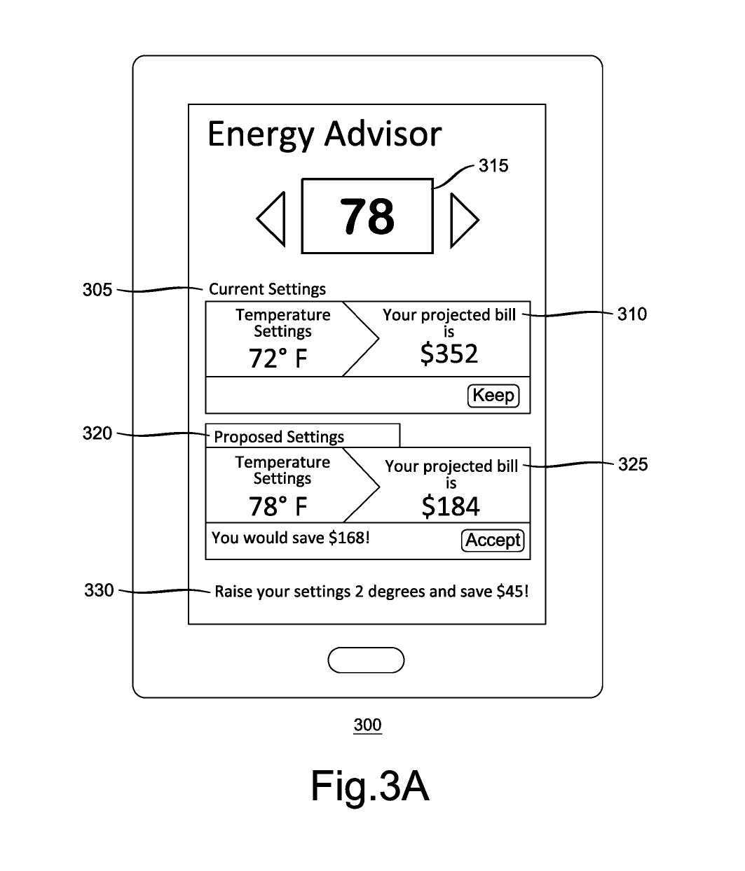

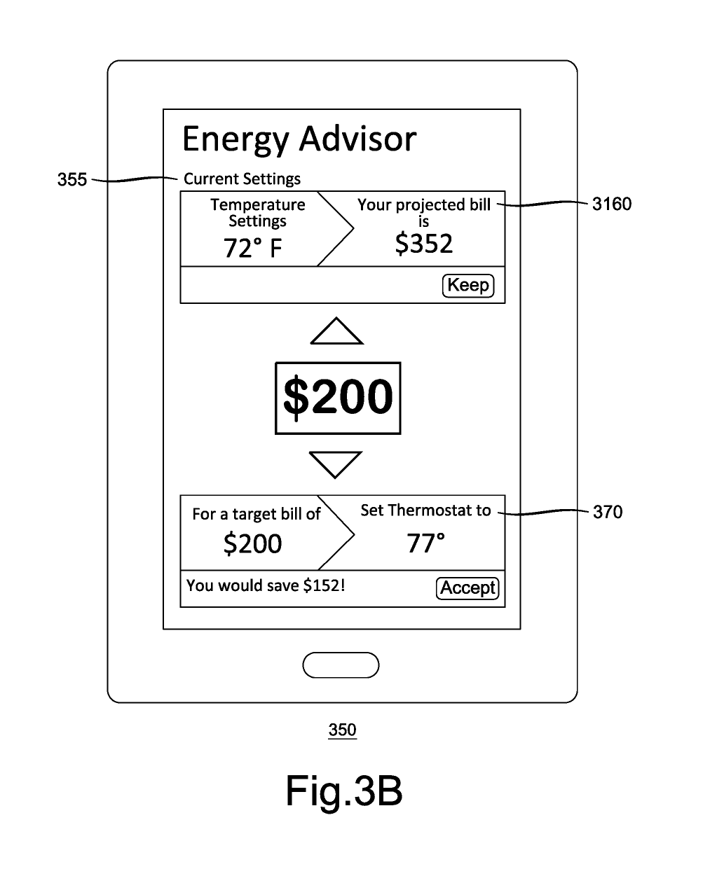

FIGS. 3A and 3B are examples of user interfaces, in accordance with various aspects of the disclosed subject matter. The interfaces may be displayed on a display screen of a computing device such as user device 205 in FIG. 2 (e.g., a mobile device, a laptop, a smart thermostat, etc.) and the information displayed in interface may be transmitted to the computing device by the energy advisor system 215 in FIG. 2.

According to various aspects of the subject technology, the energy advisor system 215 is configured to determine a predicted cost of a thermostat configuration. This information can be provided to a user to advise the user on an expected utility bill and also to empower the user to intelligently configure the Smart thermostat with the knowledge on how that configuration will affect the expected utility bill. The expected utility bill can be updated automatically, in real-time and dynamically based on changes of the thermostat and outside conditions as described below.

As illustrated in FIG. 3A, the thermostat configuration can include a temperature setting. However, in other aspects, the thermostat configuration can include temperature settings for multiple zones in a house, which zones are on, whether a fan is on, dehumidifier settings, etc. Furthermore, the thermostat configuration can include one or more scheduled configurations. For example, many thermostats enable a user to set one or more schedules based on a time (e.g., 10 am-2 pm, 4 pm-10 pm, etc.), a time of day, (e.g., morning, afternoon, evening, nighttime, etc.), a day (e.g., weekdays, weekends, Mondays, etc.), current weather (e.g., temperature, humidity, rain, cloudy, sunshine, etc.) or a condition (e.g., home, away, vacation, etc.). Costs for these scheduled configurations would be calculated similarly, but for illustrative purposes, FIG. 3A includes a simplified thermostat configuration in accordance with some aspects of the subject technology.

The interface can include a current configuration (e.g., temperature settings) 305 for a thermostat and the predicted or estimated costs 310 associated with the current configuration 305. The predicted or estimated costs 310 can be for a current time period (e.g., a current billing period), a future time period (the next week or 15 days), or another time period.

The interface can include an interface component 315 that enables a user to change the thermostat configuration or propose a new thermostat configuration via the computing device. The interface can further include a proposed configuration 320 for the thermostat and the predicted or estimated costs 325 associated with the proposed configuration 320. If the current time is within the time period (e.g., the current date is half way through a current billing period) for which a predicted cost 325 is being calculated for, the predicted cost 325 may be based on an actual or estimated cost for the elapsed period of the time period based on prior configurations and a predicted cost for the remaining period based on the proposed configuration.

According to some aspects of the subject technology, the interface may also express the relationship between a thermostat configuration and a cost based on a change in a configuration settings and a difference in cost relative to another configuration setting. For example, interface 300 specifies an example 330 where a user can raise the temperature setting for a thermostat 2 degrees higher than the current settings 305 and save $45 for the next or current time period.

According to various aspects of the subject technology, the energy advisor system 215 can be configured to generate a climate control device configuration based on a target cost. This information can be provided to enable a user to customize the configuration of the user's thermostat to target a desired utility bill cost.

For example, in FIG. 3B, the interface can include a current configuration (e.g., temperature settings) 355 for a thermostat and the predicted or estimated costs 360 associated with the current configuration 355. The predicted or estimated costs 360 can be for a current time period (e.g., a current billing period), a future time period (the next week or 15 days), or another time period.

The interface can include an interface component 365 that enables a user to select a target utility bill amount. The computing device can transmit the selected target utility bill amount to the energy advisor system 215 and the energy advisor system 215 can identify one or more configurations that will enable the user to achieve the target utility bill amount and transmit the one or more configurations back to the computing device. The interface 350 can then display the one or more configurations 370.

As illustrated in FIG. 3B, the thermostat configuration 370 can include a temperature setting. However, in other aspects, the thermostat configuration can include temperature settings for multiple zones in a house, which zones are on, whether a fan is on, dehumidifier settings, etc. Furthermore, the thermostat configuration can include one or more scheduled configurations. For example, many thermostats enable a user to set one or more schedules based on a time (e.g., 10 am-2 pm, 4 pm-10 pm, etc.), a time of day, (e.g., morning, afternoon, evening, nighttime, etc.), a day (e.g., weekdays, weekends, Mondays, etc.), or a condition (e.g., home, away, vacation, etc.).

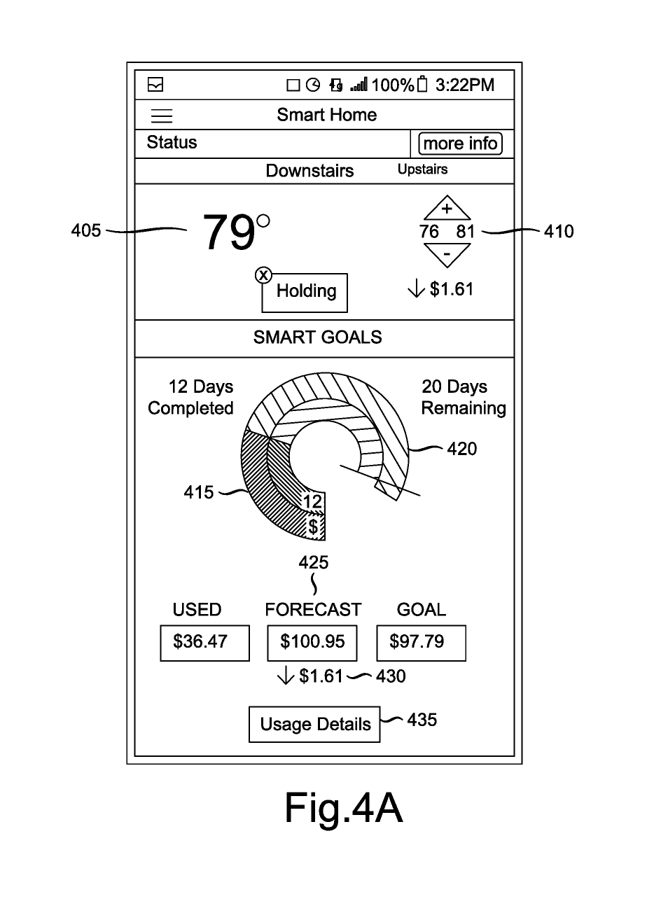

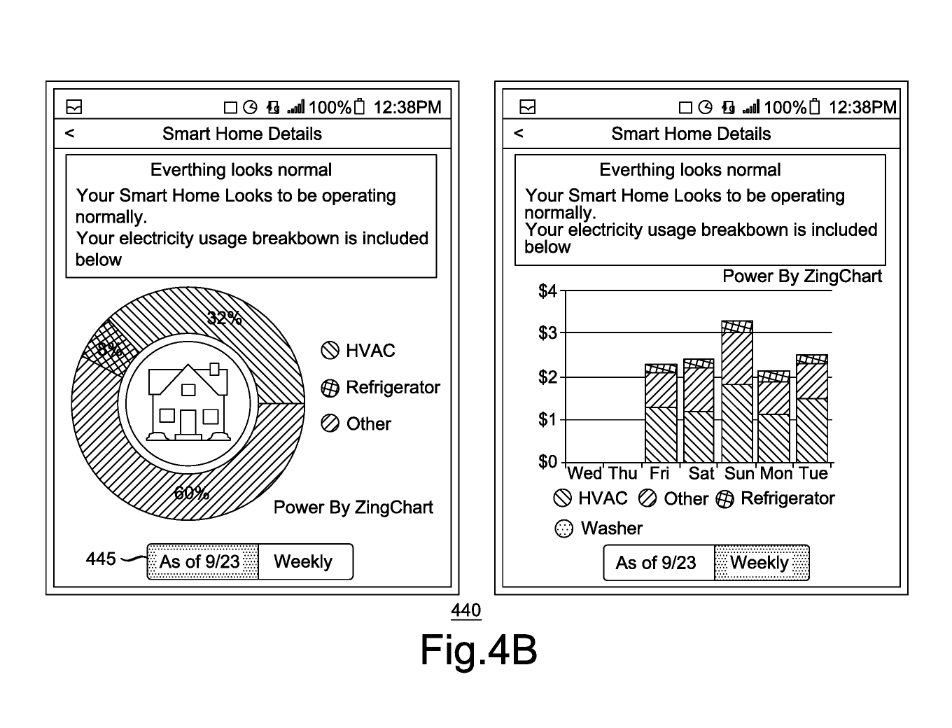

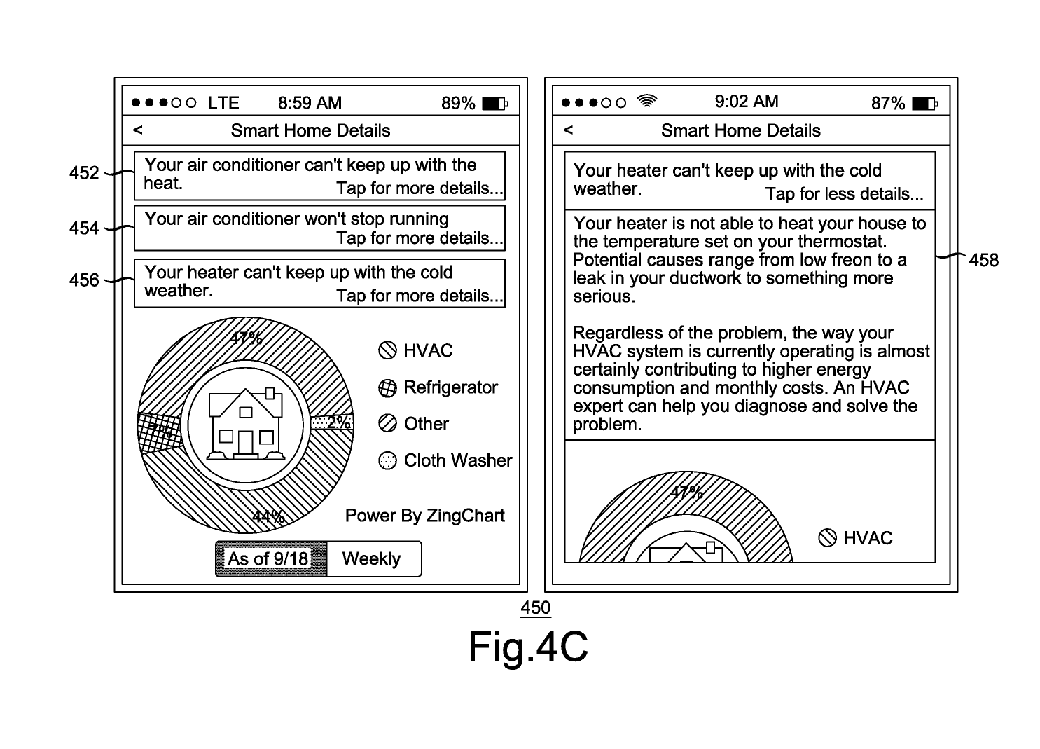

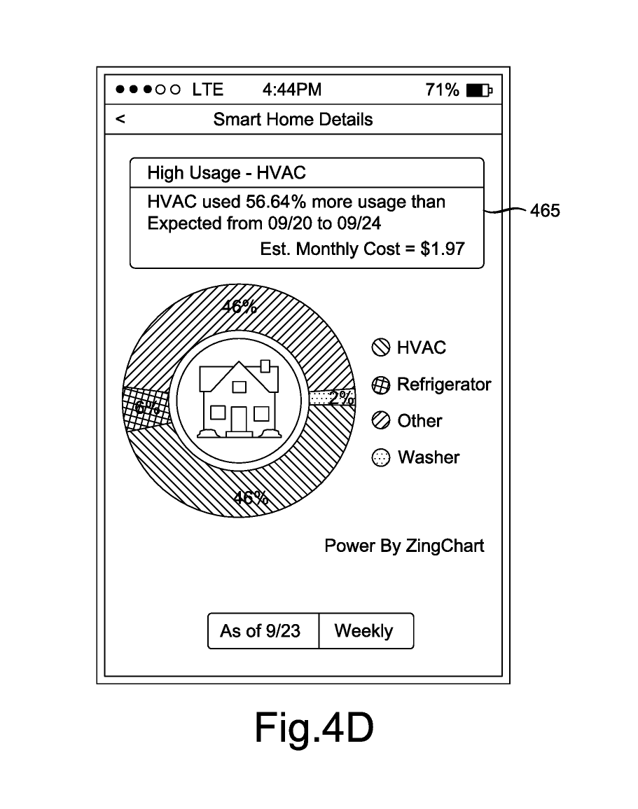

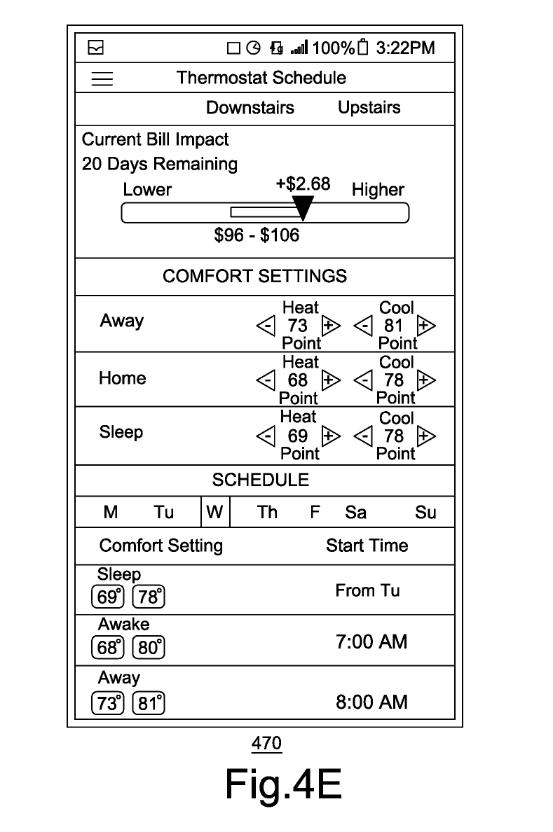

FIGS. 4A-4E are examples of additional user interfaces, in accordance with various aspects of the disclosed subject matter. The interfaces can be displayed on a display screen of a computing device such as user device 205 in FIG. 2 (e.g., a mobile device, a laptop, a smart thermostat, etc.) and the information displayed in interface may be transmitted to the computing device by the energy advisor system 215 in FIG. 2, over a communication network (e.g., Internet, etc.).

According to various aspects of the subject technology, the energy advisor system 215 is configured to determine a predicted cost of a thermostat configuration, detect anomalies in energy usage, and compute additional metrics such as the information displayed in the various interfaces shown in FIGS. 4A-4E. This information can be provided to a user to advise the user on an expected utility bill and also to empower the user to intelligently configure the Smart thermostat with the knowledge on how that configuration will affect the expected utility bill. The expected utility bill can be updated automatically, in real-time and dynamically based on changes of the thermostat and outside conditions as described below.

In FIG. 4A, the interface 400 may display the current temperature using interface element 405 and view the current status of the thermostat, which is “holding” the current thermostat settings. The current thermostat settings can be found in interface element 410, which also enable the user to increase, decrease, or otherwise change the current thermostat setting (e.g., using the + or − functionality). The interface 400 can also include a usage chart that displays how much energy is used for a particular time period (e.g., a billing cycle). The usage chart can include a completed or past portion 415 in the billing cycle (or other time period) and a portion for a remaining period 420 in the billing cycle. The inner circle for these portions 415 and 420 can include a forecasted cost for that portion of the billing cycle and the outer circle may include a goal or target cost for that portion of the billing cycle.

The interface 400 can also include additional information 425 about the cost of energy used so far in the time period, the cost of energy forecasted for the entire time period, and a goal cost for energy used in the time period. The interface can also include an interface element 430 that displays how the current thermostat setting will impact the overall bill. As is seen in interface element 430, the current thermostat setting will lower the forecasted bill by $1.61. A user may also be able to navigate to additional usage details using interface element 435. For example, a use selecting interface element 435 may lead to the interfaces shown in FIGS. 4B-4E.

FIG. 4B shows an interface 440 that displays additional usage information for the customer. For example, the energy advisor system 215 can disambiguate usage data for the customer to determine how much energy a number of appliances (e.g., HVAC, refrigerator, washer, dryer, television, electric vehicle, pool pump/heater, etc.) are responsible for. A user can toggle between daily views, weekly views, or other views using interface element 445.

According to some embodiments, the energy advisor system 215 can also monitor for and detect anomalous behaviors or data associated with a customer's usage. If anomalies are detected, a customer can be notified or informed using the various interfaces. For example, in FIG. 4B, no anomalies are detected and so the interface 440 can display a notification 446 informing the user that everything looks normal. On the other hand, if one or more anomalies are detected, the customer may be notified of the anomalies.

FIG. 4C displays an interface 450 in which notifications are provided based on detected anomalies. For example, the energy advisor system 215 can detect that a customer's air conditioner cannot keep up with the current weather (e.g., heat or cold), which can cause the display of notifications 452 or 456. The energy advisor system 215 may also detect that the air conditioner will not turn off or hasn't turned off in a long period of time, which can cause the display of notification 454.

The user can select one of the notifications to view more information. For example, if the user selects notification 456, additional information may be displayed such as in notification 458. The additional information can identify potential causes of the anomaly, potential effects, and/or steps that may be taken to correct any issues.

FIG. 4D displays another interface 460 in which notifications are provided based on detected anomalies. For example, the energy advisor system 215 can detect that a customer's HVAC usage is higher than usual or higher than expected, which can cause the display of notification 465.

FIG. 4E displays an interface 470 that shows various thermostat settings, such as a set point schedule and how the set point schedule can impact a customer's bill. For example, interface 470 displays an amount of time remaining in a billing cycle or other period of time, and the impact that the current thermostat settings or set point schedule can have on the bill. The interface 470 may also enable the user to adjust the thermostat settings or set point schedule and see the change in impact to the bill based on the changes the user inputted. The user can change the temperatures for various modes (e.g., Away, Home, Sleep, etc.) in a set point schedule or change the hours or days associated with those modes.

According to various embodiments, the interfaces may display and control a single thermostat or HVAC system or a number of thermostats and/or HVAC systems. The thermostats or HVAC systems can be spread across multiple buildings and/or locations or associated with a single building. For example, the interface 470 shows information and settings for a downstairs thermostat. However, a user can use the interface 470 to switch to other thermostats (e.g., the upstairs thermostat) and view information or change settings for a selected thermostat.

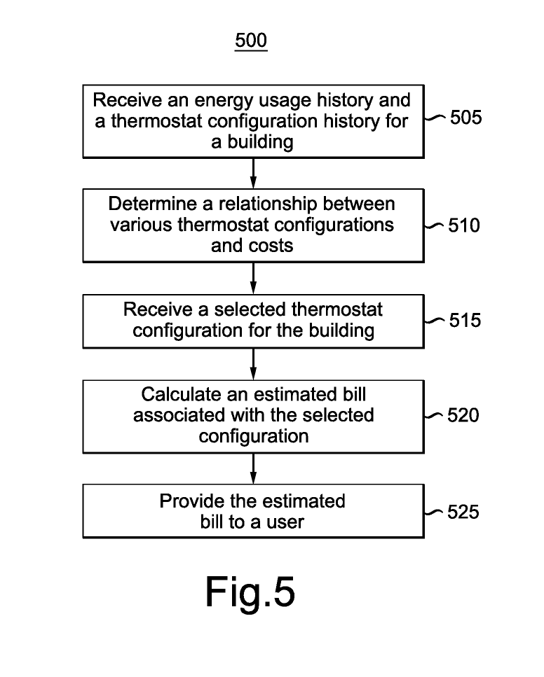

FIG. 5 illustrates an example method 500 for calculating a predicted cost of a climate control device (e.g., a Smart thermostat) configuration, in accordance with various aspects of the disclosed subject matter. The method shown in FIG. 5 is provided by way of example, as there are a variety of ways to carry out the method. Additionally, while the example method is illustrated with a particular order of blocks, those of ordinary skill in the art will appreciate that FIG. 5 and the blocks shown therein can be executed in any order that accomplishes the technical advantages of the present disclosure and can include fewer or more blocks than illustrated. Each block shown in FIG. 5 represents one or more processes, methods or subroutines, carried out in the example method. The blocks shown in FIG. 5 can be implemented on devices illustrated in FIG. 2 such as, for example, the energy advisor system.

At operation 505, the energy advisor system can receive an energy usage history and a thermostat configuration history for a building. The energy usage history can include time-series data specifying a history for energy usage for the building over a number of discrete time periods. The energy usage history can include data associated with an amount of energy used, a cost associated with the amount of energy used, or both. The cost associated with the amount of energy used can also be calculated by the energy advisor system based on, for example, a rate schedule. The thermostat configuration history for the building can include time series data specifying the thermostat configuration over a number of discrete time periods. As described above, the thermostat configuration can include temperature settings and/or a schedule of settings over time.

At operation 510, the energy advisor system can determine a relationship between various thermostat configurations and their associated costs based on the energy usage history and the thermostat configuration history. The relationship can be implemented as a formula, a model, mapping, or some other representation. Various techniques, including machine-learning or statistical modeling can be used (e.g., training a neural network, etc.). According to some aspects of the subject technology, a history of weather conditions (e.g., time series data including temperature, precipitation, wind speed, humidity, cloud cover, etc.) at or near the building may be used to refine the relationship.

At operation 515, the energy advisor system can receive a selected thermostat configuration for the building. The selected thermostat configuration can be received from a user device, a smart thermostat, or other device and may represent the current thermostat configuration, a proposed configuration, or a configuration a user wishes to implement. The energy advisor system, at operation 520, can calculate an estimated bill associated with the selected thermostat configuration based on the relationship between various thermostat configurations and their costs. For example, the energy advisor system can input the selected thermostat configuration into the model, formula, or mapping to identify an estimated bill. The energy advisor system can further base the estimated bill on an elapsed portion of a billing period, an estimated cost for the elapsed portion of the billing period, and a remaining portion of the billing period. The rate schedule can further be used to refine the calculation of the estimated bill.

Once an estimated bill is calculated, the estimated bill can be provided to a user at operation 525. The estimated cost can be provided to a user to notify the user about an expected bill amount and/or enable the user to make informed decisions on how to configure a climate control device and the effects of the configuration. In other examples, the user can provide a requested bill amount and the energy advisor system can provide a temperature schedule that would provide approximately the requested bill amount.

Data about the thermal efficiency of a building can also be used to determine and/or refine the relationship between various thermostat configurations and their costs. The thermal efficiency data (e.g., a score or other metric) can be received from a third party of calculated by the energy advisor system.

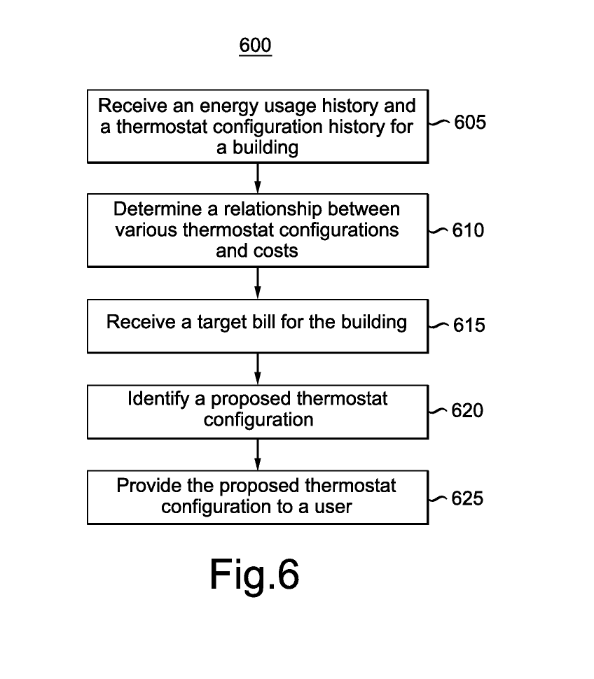

FIG. 6 illustrates an example method 600 for generating a climate control device configuration based on a target cost, in accordance with various aspects of the disclosed subject matter. The method shown in FIG. 6 is provided by way of example, as there are a variety of ways to carry out the method. Additionally, while the example method is illustrated with a particular order of blocks, those of ordinary skill in the art will appreciate that FIG. 6 and the blocks shown therein can be executed in any order that accomplishes the technical advantages of the present disclosure and can include fewer or more blocks than illustrated. Each block shown in FIG. 6 represents one or more processes, methods or subroutines, carried out in the example method. The blocks shown in FIG. 6 can be implemented on devices illustrated in FIG. 2 such as, for example, the energy advisor system.

At operation 605, the energy advisor system can receive an energy usage history and a thermostat configuration history for a building. The energy usage history can include time-series data specifying a history for energy usage for the building over a number of discrete time periods. The energy usage history can include data associated with an amount of energy used, a cost associated with the amount of energy used, or both. The cost associated with the amount of energy used can also be calculated by the energy advisor system based on, for example, a rate schedule. The thermostat configuration history for the building can include time series data specifying the thermostat configuration over a number of discrete time periods. As described above, the thermostat configuration can include temperature settings and/or a schedule of settings over time.

At operation 610, the energy advisor system can determine a relationship between various thermostat configurations and their associated costs based on the energy usage history and the thermostat configuration history. The relationship can be implemented as a formula, a model, mapping, or some other representation. Various techniques, including machine-learning or statistical modeling may be used (e.g., training a neural network, etc.). According to some aspects of the subject technology, a history of weather conditions (e.g., time series data including temperature, precipitation, wind speed, humidity, cloud cover, etc.) at or near the building may be used to refine the relationship.

At operation 615, the energy advisor system may receive a target bill for the building. The target bill may be received from a user device, a smart thermostat, or other device. The energy advisor system, at operation 620, can identify a proposed thermostat configuration based on the relationship between various thermostat configurations and their costs. For example, the energy advisor system can input the target bill into the model, formula, or mapping to identify a proposed configuration. According to some aspects of the subject technology, the energy advisor system can further base the proposed configuration on an elapsed portion of a billing period, an estimated cost for the elapsed portion of the billing period, and a remaining portion of the billing period. The rate schedule can further be used to refine the calculation of the proposed configuration.

At operation 625, the energy advisor system can provide the proposed thermostat configuration to the user. The user can accept or reject the proposed configuration. If the energy advisor system receives an acceptance of the configuration, the energy advisor system can transmit the proposed configuration to a smart thermostat for implementation on the smart thermostat. If the energy advisor system receives a rejection of the proposed configuration, the energy advisor system can identify a secondary proposed thermostat configuration to present to the user.

Data about user preferences or tolerances with respect to environmental conditions in the building can also be used to filter out proposed configurations that are not acceptable to the user and/or rank possible proposed configurations in order to select a best configuration. In some implementations, data about the thermal efficiency of the building can also be used to rank possible proposed configurations and/or select a best configuration.

Aspects of the subject technology also relate to providing users with an estimated cost of a thermostat configuration change. For example, users may be interested in both the comfort that a certain thermostat configuration provides as well as energy usage costs. In order to make a more informed choice, embodiments of the present disclosure enable a user to make changes to thermostat configurations and provide the user with cost information associated with the change in configurations so that the user can weigh the factors and make a personalized choice.

The cost information can be derived using a load forecast engine that collects various information and generates a series of load forecasts that predict the amount of energy that will be used based on a given thermostat configuration. The information used by the load forecast engine can include, for example, historical meter data (e.g., smart meter data) or usage data for a property, weather data (historical weather data and/or weather forecasts), a thermostat configuration, internal environmental conditions, and/or property data.

The thermostat configuration can be in the form of one or more set point schedules that list a series of target settings for various time periods in a given day, week, month, or year. For example, one set point schedule may be set for a week and specify that Mondays through Fridays from 8 am to 6 pm, the target temperature is 78 degrees, from 6 pm to midnight, the target temperature is 70 degrees, and from midnight to 8 am, the target temperature is 74 degrees. The set point schedule can further specify that on weekends, from Sam to midnight, the target temperature is 70 degrees and from midnight to 8 am, the target temperature is 76 degrees. In other words, a set point schedule may be configured to provide a periodic (e.g., hourly) schedule of target temperatures.

The internal environmental conditions can be collected from one or more sensors inside the property and include the detected temperature or humidity. The property data can include building characteristics such as a year the building was built or renovated, square footage, layout and number of stories, how much of the building is underground (e.g., basements), directional orientation (facing North, South, East or West), roofing type, insulation factor, attic ventilation, exterior sheathing (brick, stucco, wood, concrete, etc.), the air conditioning's efficiency rating/capability, window U-Factor, window solar heat gain coefficient, window, and building air leakage, etc.

The load forecast engine may use various methods, functions, or algorithms to generate a load forecast that predicts the amount of energy that will be used based on the given thermostat configuration. For example, in some embodiments, one or more machine learning models or artificial intelligence techniques may be used to generate one or more load forecasts, for example, a neural network, etc. However, in many cases, the computational resources (e.g., time, memory, processing power, network bandwidth) needed to generate a load forecast is quite high. Additionally, users may not wish to wait for each load forecast to be generated in real time.

Accordingly, batch requests can be sent to the load forecast engine and/or the load forecast engine can be configured to generate a series of load forecasts based on a given thermostat configuration (e.g., a set point schedule). For example, one load forecast can be generated for the current thermostat set point schedule of target temperatures. The load forecast engine can also be configured to generate load forecasts based on incremental changes to the provided thermostat set point schedule. For example, a load forecast can be generated for a one degree increase in each time period in the set point schedule, a load forecast can be generated a for a two degree increase in each time period in the set point schedule, a load forecast may be generated for a three degree increase in each time period in the set point schedule, and so on. Similarly, load forecasts can be generated for a one degree decrease in each time period in the set point schedule, a two degree decrease in each time period in the set point schedule, a three degree decrease in each time period in the set point schedule, and so on. According to some embodiments, the number of load forecasts generated by the load forecast engine can be limited to a certain range (e.g., plus or minus 5 degrees from the current thermostat set point schedule) in order to conserve computing resources.

The energy advisor can system store the series of load forecasts generated by the load forecast engine and can use the load forecasts to provide the user with cost estimates for the current thermostat set point schedule and changes to the thermostat set point schedule. For example, one of the load forecasts generated by the load forecast engine corresponds to the current set point schedule. Accordingly, the energy advisor system can select that load forecast and can translate the load forecast into cost information based on the rate schedule, as described above.

To calculate a cost estimate for one or more changes to the thermostat set point schedule, the energy advisor system can receive a change in the current set point schedule from a user device (e.g., a thermostat, a mobile device, a home hub device/controller, etc.). The change in the set point schedule can include a change of target temperatures for one or more time periods in the set point schedule. The energy advisor system generates a hybrid load forecast that represents the change in the set point schedule received from the user device by selecting portions of a number of load forecasts generated by the load forecast engine that correspond to the changes in the set point schedule.

In one simplified example for illustrative purposes, a current set point schedule can be for a single day where the target temperature is 70 degrees from Sam to midnight and 76 degrees from midnight to 8 am. The load forecast engine can generate load forecasts for the current set point schedule and load forecasts for each degree of deviation from the current set point schedule within the range of ±5 degrees for a total of 11 load forecasts.

A user can want to see the difference between the current set point schedule and a change of +1 degrees from Sam till midnight and input the change into a client device. The client device transmits the change to the energy advisor system where the energy advisor system can generate a hybrid load forecast for the change. The hybrid load forecast can be a combination of the midnight till Sam (the portion that the user did not change) portion of the load forecast for the current set point schedule and the Sam till midnight (the portion that the user changed) portion of the load forecast corresponding to the +1 degree load forecast.

Similarly, the inputted change can specify a change of +2 degrees from Sam till midnight and a change of +4 degrees from midnight till 8 am. Accordingly, the hybrid load forecast generated by the energy advisor system may be a combination of the Sam till midnight portion of the load forecast corresponding to the +2 degree load forecast and the midnight till 8 am portion of the load forecast corresponding to the +4 degree load forecast.

In still another example, the inputted change may specify no change from noon till 4 pm, a change of −2 degrees from 4 pm till midnight, and a change of +4 degrees from midnight till noon. Accordingly, the hybrid load forecast generated by the energy advisor system can be a combination of the noon till 4 pm portion of the load forecast corresponding to the current set point schedule, the 4 pm till midnight portion of the load forecast corresponding to the −2 degree load forecast, and the midnight till noon portion of the load forecast corresponding to the +4 degree load forecast.

In some example, the difference between the current set point schedule and a specified change by the user can be displayed as a grid based on the plus or minus a predefined threshold from the specified change provided by the user. For example, when the user specifies +1, the grid can show the estimated costs for +1, +2, +3, +4, +5 and −1, −2, −3, −4, −5, etc.

Once portions of the series of load forecasts corresponding to the change are selected to form a hybrid load forecast, the energy advisor system calculates cost information for the change based on the hybrid load forecast and the rate schedule. The cost information can include an estimated cost of running the climate control device based on the current thermostat configuration, an estimated cost of running the climate control device based on the change to thermostat configuration, an estimated cost of the entire home or property based on the current thermostat configuration, an estimated cost of the entire home or property based on the change to the thermostat configuration, or a comparison of the various cost estimates.

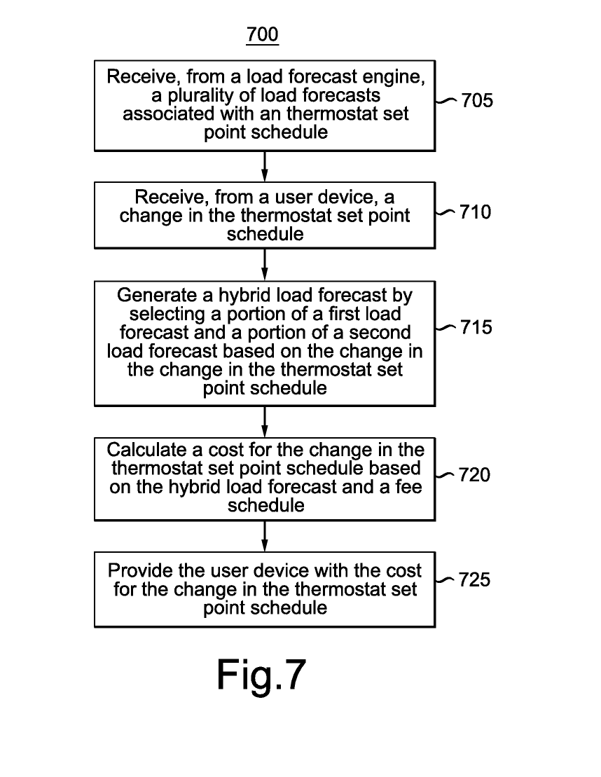

FIG. 7 illustrates an example method 700 for calculating an estimated cost of a change in a thermostat set point schedule, in accordance with various aspects of the disclosed subject matter. The method shown in FIG. 7 is provided by way of example, as there are a variety of ways to carry out the method. Additionally, while the example method is illustrated with a particular order of blocks, those of ordinary skill in the art will appreciate that FIG. 7 and the blocks shown therein can be executed in any order that accomplishes the technical advantages of the present disclosure and can include fewer or more blocks than illustrated. Each block shown in FIG. 7 represents one or more processes, methods or subroutines, carried out in the example method. The blocks shown in FIG. 7 can be implemented on devices illustrated in FIG. 2 such as, for example, the energy advisor system.

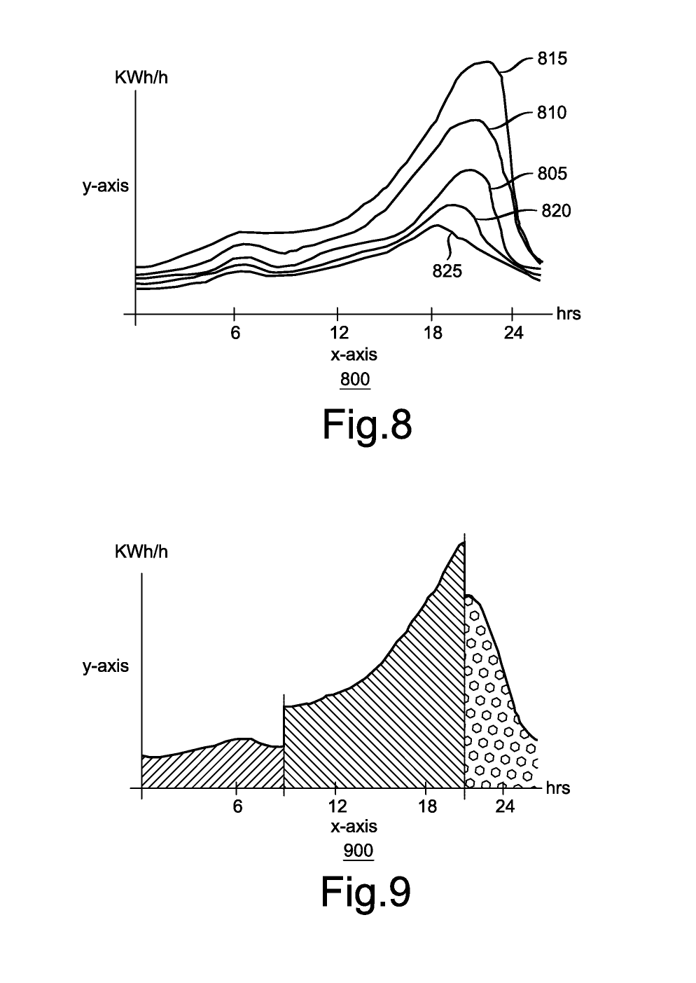

As discussed above, the energy advisor system, a third-party, or a combination of sources can provide the load forecast engine with, at least one of meter data, weather data, property data, interior condition data, or the thermostat set point schedule. The load forecast engine is configured to generate a number of load forecasts associated with the provided set point schedule and transmit the load forecasts (shown in FIG. 8) to the energy advisor system. At operation 705, the energy advisor system receives the load forecasts associated with a thermostat set point schedule.

FIG. 8 is a graph 800 illustrating a number of load forecasts associated with a set point schedule, in accordance with various aspects of the subject technology. The load forecasts can represent the energy a particular set point schedule uses over time. For example, load forecast 805 can specify the kilowatt hours (kWh) used per hour over a 24 hour period based on a particular set point schedule. The set point schedule may be for a specific temperature setting or for a particular set point schedule such as the current or default set point schedule.

Load forecast 810 can specify the kilowatt hours (kWh) used per hour over a 24 hour period based on a +1 degree deviation from that set point schedule and load forecast 815 can specify the kilowatt hours (kWh) used per hour over a 24 hour period based on a +2 degree deviation from that set point schedule. Similarly, load forecast 820 can specify the kilowatt hours (kWh) used per hour over a 24 hour period based on a −1 degree deviation from that set point schedule and load forecast 825 may specify the kilowatt hours (kWh) used per hour over a 24 hour period based on a −2 degree deviation from that set point schedule.

Although the graph 800 shows five load forecasts, additional or fewer load forecasts can also be used. Furthermore the deviation for the load forecasts can be more or less than 1 degree increments and/or non-uniform. Furthermore, the time scale for the load forecasts may not necessarily be a 24 hour period as some set point schedules may last for longer periods. For example, load forecasts can be for a week, a month, a billing period, etc.

Returning to FIG. 7, at operation 710, the energy advisor system also receives a change in the thermostat set point schedule from the user device. The energy advisor system generates a hybrid load forecast (shown in FIG. 9) by selecting portions of load forecasts that correspond to the change in the thermostat set point schedule at operation 715.

FIG. 9 is a graph 900 illustrating a hybrid load forecast associated with a change in a thermostat set point schedule, in accordance with various aspects of the subject technology. The hybrid load forecasts can represent the energy used over time associated with a change or multiple changes to thermostat set point schedule (e.g., the current or default thermostat set point schedule). For example, hybrid load forecast shown in the graph 900 can specify the kilowatt hours (kWh) used per hour over a 24 hour period based a −2 degree change from the current set point schedule from hours 0-9, a +2 degree change from the current set point schedule from hours 9-21 (e.g., 9 am to 9 pm), and no change from the current set point schedule from hours 21-24.

Accordingly, the hybrid load forecast of FIG. 9 can be composed of the portion of the load forecast 825 from FIG. 8 from hours 0-9, the portion of the load forecast 815 from hours 9-21 (e.g., 9 am to 9 pm), and the portion of the load forecast 805 from hours 21-24. Although the hybrid load forecast of FIG. 9 is composed of 3 portions, the system supports additional portions and fewer portions.

Based on the hybrid load forecast and a rate schedule, the energy advisor system can calculate a cost for the change at operation 720 and provide the cost for the change to the user device at operation 725. The cost for the change can be provided along with the cost of the unchanged thermostat set point schedule and/or other comparisons or metrics based on the costs. The information generated by the energy advisor system can be transmitted to a user device and displayed in an application running on the user device (e.g., shown in FIGS. 3-4).

A complimentary and supplemental control strategy to the diagnostic procedure described above is a system and method to dispatch events for thermostats to affect demand and save money and/or energy. The system and method can include custom control of smart thermostats (e.g., devices that can be used with home automation and are responsible for controlling a home's heating and/or air conditioning). Each smart thermostat can be tagged and associated with a group (e.g., a plurality of smart thermostats from different houses and locations). The groups can receive group-based dispatched events (e.g., raise/lower temperature, activate/deactivate heating or cooling, etc.).

In some examples, data associated with the smart thermostat (e.g., house profile, user tolerances, occupancy of house, etc.) can be combined with pricing data, demand data, weather data, load data, etc. This plurality of data can be combined to modify set points of the house (e.g., enables the provider of electricity to alter the settings of the smart thermostat based on the thermostat data and the current market prices of energy). In some examples, this process can be automated (e.g., automatically performed).

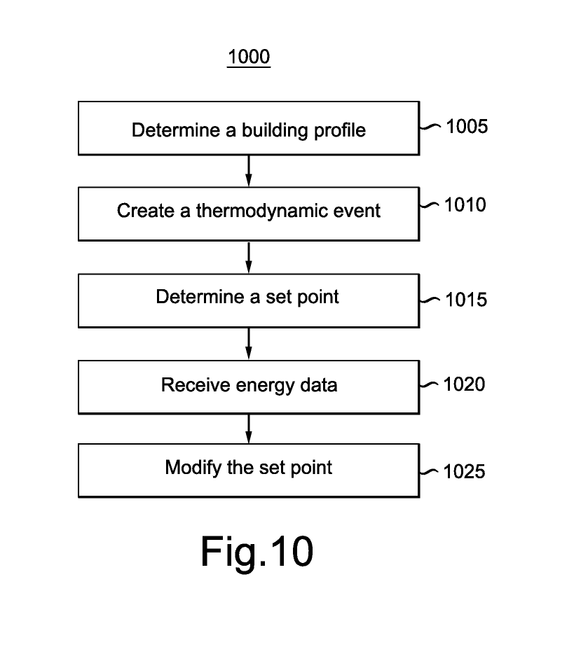

FIG. 10 illustrates an example method 1000 of dispatching events to smart thermostats, in accordance with various aspects of the subject technology. The method shown in FIG. 10 is provided by way of example, as there are a variety of ways to carry out the method. Additionally, while the example method is illustrated with a particular order of blocks, those of ordinary skill in the art will appreciate that FIG. 10 and the blocks shown therein can be executed in any order that accomplishes the technical advantages of the present disclosure and can include fewer or more blocks than illustrated.

Each block shown in FIG. 10 represents one or more processes, methods or subroutines, carried out in the example method. The blocks shown in FIG. 10 can be implemented on devices illustrated in FIG. 1 and include smart thermostat 104. The flow chart illustrated in FIG. 10 will be described in relation to and make reference to at least the devices of FIG. 1.

FIG. 10 illustrates an example method 1000 for dispatching events to smart thermostats. Method 1000 can begin at block 1005. At block 1005, a building profile can be determined as disclosed above utilizing the described diagnostic tools and procedures. The building profile may be a thermodynamic model or other profile of the building that specifies the building's thermal efficiency.

As described above, at block 1010, a thermodynamic event can be created. For example, smart thermostat 104 can incrementally adjust (e.g., raise or lower) the temperature of building 102 (e.g., by server, smart thermostat, etc.). Smart thermostat 104 can then monitor the status of building 102 over a predetermined period of time (e.g., to determine time it takes for temperature to reach the adjusted temperature). The time to reach the adjusted temperature can be different depending on a variety of factors (e.g., house profile, weather, etc.). Block 1010 can be repeated over a period of time to determine the status under different conditions and/or times.

At block 1015, a set point can be determined (e.g., by server, smart thermostat, etc.). For example, the set point can be a baseline reading (e.g., energy consumption, etc.) for the building. The set point can be determined based on the thermodynamic events readings (from block 1010) and other factors (e.g., weather, efficiency of appliance and buildings, etc.). The set point can be automatically adjusted based on time of year (e.g., summer, winter, etc.) and/or location of building 102 (e.g., Los Angeles, Houston, Boston, etc.).

At block 1020, energy data can be received (e.g., by server, smart thermostat, etc.). For example, price of energy, demand of energy, required load of energy, etc. In some examples, the energy data can be received in real-time.

At block 1025, the set point can be modified (e.g., by server, smart thermostat, etc.). For example, based on the energy data received the set point of building 102 can be modified. In some examples, the set point can be modified to increase the energy consumption of the building. In other examples, the set point can be modified to decrease the energy consumption of the building. For example, during hot weather (e.g., summer in Houston) energy consumption can be the greatest and most expensive during the daytime hours (e.g., cooling the building). Conversely, energy consumption is cheapest during nighttime hours. Accordingly, by modifying the set point, energy can be conserved during the day and used during the night. For example, during the nighttime hours the temperature of the building 104 can be lowered a few degrees in order to keep the building cooler during the daytime hours. In other examples, batteries 118 can be charged during nighttime hours and used to power the house during the more expensive daytime hours.

Method 1000 of FIG. 10 can be performed in real-time across a variety of buildings. The method can also suggest optimal schedules for pre-cooling and heating buildings based on the set points and factors. Carrying out method 1000 across a variety of buildings can optimize the procurement of energy during off-peak times. In some embodiments, energy can be shared between buildings during peak and off-peak times. Method 1000 can also be automated or automatically performed from the server.

According to some embodiments, pre-conditioning (e.g., pre-cooling or pre-heating) of one or more buildings can be used as a financial instrument to store thermal energy in a building for later use. Pre-conditioning schedules may be used to reduce the amount of energy a building uses or the cost for the energy the building uses.

Disclosed are systems and methods for creating and utilizing energy signature in forecasting inefficiencies and failures in electrical appliances. Each electrical appliance can have a unique energy signature (e.g., how it consumes electricity). For example, a refrigerator could have an energy signature of a square waveform. When connected to a building (e.g., building 102) an appliance can have its digital signature determined at meter 116. The meter can then be transmitted and stored at a server. At predetermined intervals, the server stored energy signatures can be compared to current energy signatures. For examples, if the energy signatures are the same the appliance is operating correctly. However, if the energy signatures are different the appliance could be close to failure, running inefficiently, needs service, etc. Upon detection of a variance, a notification can be transmitted.

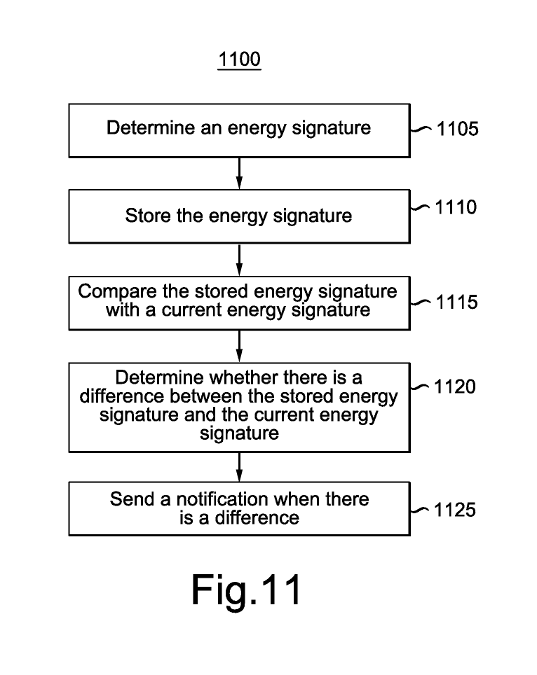

FIG. 11 illustrates an example method 1100 of determining appliance inefficiencies through energy signatures. The method shown in FIG. 11 is provided by way of example, as there are a variety of ways to carry out the method. Additionally, while the example method is illustrated with a particular order of blocks, those of ordinary skill in the art will appreciate that FIG. 11 and the blocks shown therein can be executed in any order that accomplishes the technical advantages of the present disclosure and can include fewer or more blocks than illustrated.

Each block shown in FIG. 11 represents one or more processes, methods or subroutines, carried out in the example method. The blocks shown in FIG. 11 can be implemented on devices illustrated in FIG. 1 including smart thermostat 104. The flow chart illustrated in FIG. 11 will be described in relation to and make reference to at least the devices of FIG. 1.

At block 1110, an energy signature is determined. For example, meter 116 can determine based on the consumption of energy an energy signature of an appliance consuming energy in building 102. For example, refrigerators, pool pumps, battery banks, dish washers, washer/dryer, etc. In some examples, the energy signature can be variations of sine waveforms, cosine waveforms, triangle waveforms, saw tooth waveforms, square waveforms, or any other type or combination of waveforms. In some examples, an energy signature can be determined for one or more appliances consuming energy from building 102.

At block 1120, the energy signature is stored. For example, the energy signature can be stored locally at smart meter 116. In other examples, the energy signature can be stored remotely at a server (or cloud, etc.).

At block 1130, the stored energy signature is compared with a current energy signature. At a predetermined time interval, a current energy signature can be captured (e.g., at smart meter 116). The current energy signature can be compared with the stored energy signature. When there is a difference between the energy signatures, the appliance can be operating in a less than optimal manner. For example, a different energy signature of an appliance can determine the appliance is operating in an inefficient manner (and thus is wasting energy). In other examples, a different energy signature of an appliance can determine the appliance is close to failure. In some examples, the comparison can be performed at predetermined time periods (e.g., weekly, monthly, annually, etc.).

At block 1140, it is determined if there is a difference between the stored energy signature by comparison with a current energy signature. If there is not a difference, method 300 can return to step 330. If there is a difference, method 300 can proceed to block 350.

At block 1150, a notification can be sent. For example, the owner of building 102 can be sent a notification the refrigerator is potentially failing or running inefficiently. The user can then investigate any issues with the refrigerator to prevent failure and waste of energy consumption.

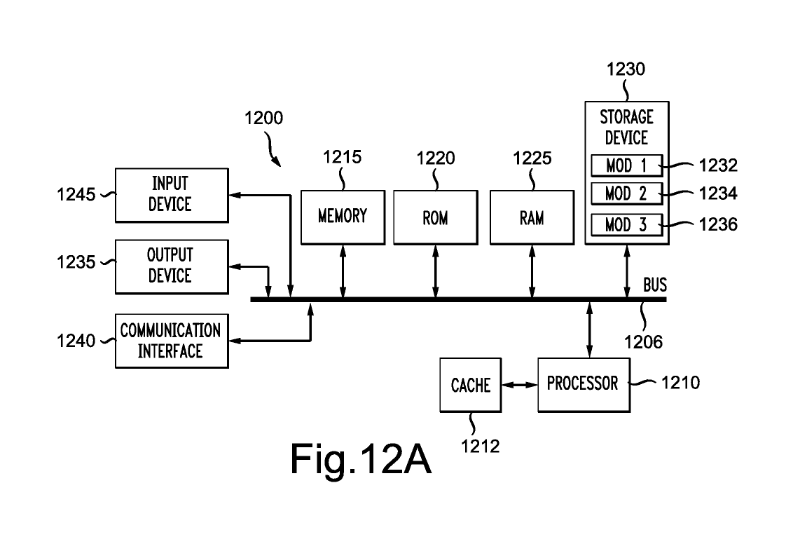

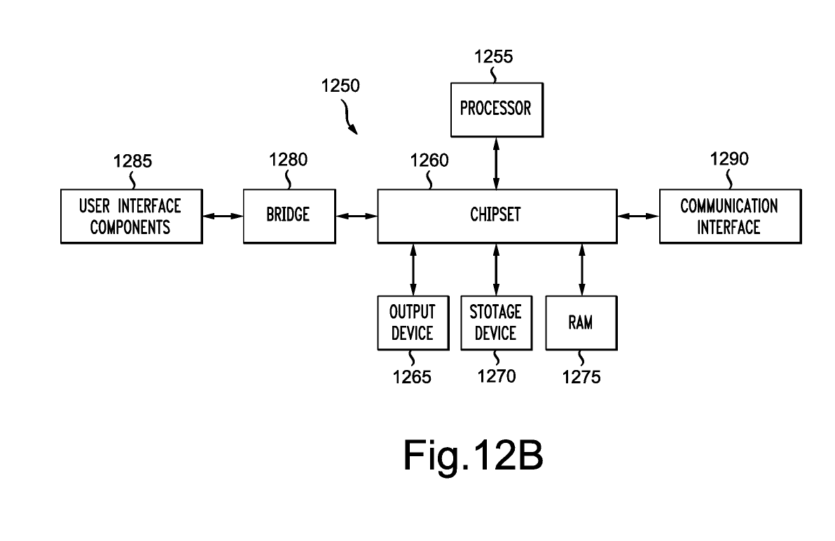

FIG. 12A and FIG. 12B show exemplary possible system aspects (e.g., smart thermostats, smart meters, servers, etc.). The more appropriate aspect will be apparent to those of ordinary skill in the art when practicing the present technology. Persons of ordinary skill in the art will also readily appreciate that other system aspects are possible.

FIG. 12A illustrates an example architecture for a conventional bus computing system 1200 wherein the components of the system are in electrical communication with each other using a bus 1205. The computing system 1200 can include a processing unit (CPU or processor) 1210 and a system bus 1205 that may couple various system components including the system memory 1215, such as read only memory (ROM) in a storage device 1220 and random access memory (RAM) 1225, to the processor 1210. The computing system 1200 can include a cache 1212 of high-speed memory connected directly with, in close proximity to, or integrated as part of the processor 1210. The computing system 1200 can copy data from the memory 1215 and/or the storage device 1230 to the cache 1212 for quick access by the processor 1210. In this way, the cache 1212 can provide a performance boost that avoids processor delays while waiting for data. These and other modules can control or be configured to control the processor 1210 to perform various actions. Other system memory 1215 may be available for use as well. The memory 1215 can include multiple different types of memory with different performance characteristics. The processor 1210 can include any general purpose processor and a hardware module or software module, such as module 1 1232, module 2 1234, and module 3 1236 stored in storage device 1230, configured to control the processor 1210 as well as a special-purpose processor where software instructions are incorporated into the actual processor design. The processor 1210 may essentially be a completely self-contained computing system, containing multiple cores or processors, a bus, memory controller, cache, etc. A multi-core processor may be symmetric or asymmetric.

To enable user interaction with the computing system 1200, an input device 1245 can represent any number of input mechanisms, such as a microphone for speech, a touch-protected screen for gesture or graphical input, keyboard, mouse, motion input, speech and so forth. An output device 1235 can also be one or more of a number of output mechanisms known to those of skill in the art. In some instances, multimodal systems can enable a user to provide multiple types of input to communicate with the computing system 1200. The communications interface 1240 can govern and manage the user input and system output. There may be no restriction on operating on any particular hardware arrangement and therefore the basic features here may easily be substituted for improved hardware or firmware arrangements as they are developed.

Storage device 1230 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof.

The storage device 1230 can include software modules 1232, 1234, 1236 for controlling the processor 1210. Other hardware or software modules are contemplated. The storage device 1230 can be connected to the system bus 1205. In one aspect, a hardware module that performs a particular function can include the software component stored in a computer-readable medium in connection with the necessary hardware components, such as the processor 1210, bus 1205, output device 1235, and so forth, to carry out the function.

FIG. 12B illustrates an example architecture for a conventional chipset computing system 1250 that can be used in accordance with an embodiment. The computing system 1250 can include a processor 1255, representative of any number of physically and/or logically distinct resources capable of executing software, firmware, and hardware configured to perform identified computations. The processor 1255 can communicate with a chipset 1260 that can control input to and output from the processor 1255. In this example, the chipset 1260 can output information to an output device 1265, such as a display, and can read and write information to storage device 1270, which can include magnetic media, and solid state media, for example. The chipset 1260 can also read data from and write data to RAM 1275. A bridge 1280 for interfacing with a variety of user interface components 1285 can be provided for interfacing with the chipset 1260. The user interface components 1285 can include a keyboard, a microphone, touch detection and processing circuitry, a pointing device, such as a mouse, and so on. Inputs to the computing system 1250 can come from any of a variety of sources, machine generated and/or human generated.

The chipset 1260 can also interface with one or more communication interfaces 1290 that can have different physical interfaces. The communication interfaces 1290 can include interfaces for wired and wireless LANs, for broadband wireless networks, as well as personal area networks. Some applications of the methods for generating, displaying, and using the GUI disclosed herein can include receiving ordered datasets over the physical interface or be generated by the machine itself by processor 1255 analyzing data stored in the storage device 1270 or the RAM 1275. Further, the computing system 1200 can receive inputs from a user via the user interface components 1285 and execute appropriate functions, such as browsing functions by interpreting these inputs using the processor 1255.

It will be appreciated that computing systems 1200 and 1250 can have more than one processor 1210 and 1255, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving, from a load forecast engine, a plurality of load forecasts associated with a thermostat set point schedule;
receiving, from a user device, a change in the thermostat set point schedule;
generating a hybrid load forecast by selecting a portion of a first load forecast in the plurality of load forecasts and a portion of a second load forecast in the plurality of the load forecasts based on the change in the change in the thermostat set point schedule;
calculating a usage characteristic cost for the change in the thermostat set point schedule based on the hybrid load forecast and a fee schedule; and
providing the user device with the usage characteristic cost for the change in the thermostat set point schedule.

2. The computer-implemented method of claim 1, wherein the user device is a thermostat.

3. The computer-implemented method of claim 1, wherein the user device is a mobile device.

4. The computer-implemented method of claim 1, further comprising transmitting, to the load forecast engine, at least one of meter data, weather data, property data, interior condition data, or the thermostat set point schedule.

5. The computer-implemented method of claim 1, wherein the plurality of load forecasts associated with the thermostat set point schedule comprises a third load forecast associated with the thermostat set point schedule, the method further comprising:
calculating a cost for the thermostat set point schedule based on the third load forecast and the fee schedule; and
providing the user device with the cost for the thermostat set point schedule.

6. The computer-implemented method of claim 5, further comprising:
generating a comparison between the cost for the thermostat set point schedule and the cost for the change in the thermostat set point schedule; and
providing the user device with the comparison.

7. The computer-implemented method of claim 1, wherein the thermostat set point schedule is a current thermostat set point schedule for a thermostat of a building.

8. The computer-implemented method of claim 1, wherein the thermostat set point schedule comprises a series of target temperature settings over time, and wherein the change in the thermostat set point schedule comprises at least one alteration, for at least one period of time, of a target temperature setting in the series of target temperature settings.

9. A computer-implemented method comprising:
receiving an energy usage history and a thermostat configuration history for a building;
determining, based on the energy usage history and the thermostat configuration history, a relationship between various thermostat configurations and costs;
receiving a selected thermostat configuration for the building;
calculating, based on the selected thermostat configuration and the relationship between the various thermostat configurations and the costs, an estimated bill associated with the selected thermostat configuration; and
providing the estimated bill to a user device.

10. The computer-implemented method of claim 9, wherein the energy usage history comprises time-series data specifying an energy usage for the building over a number of discrete time periods.

11. The computer-implemented method of claim 9, wherein the relationship between the various thermostat configurations and the costs is a model determined using machine-learning techniques.

12. The computer-implemented method of claim 9, wherein the selected thermostat configuration is received from the user device.

13. The computer-implemented method of claim 9, further comprising:
receiving a target bill for the building;
identifying, based on the target bill and the relationship between the various thermostat configurations and the costs, an proposed thermostat configuration for the building; and
provide the proposed thermostat configuration to the user device.

14. The computer-implemented method of claim 13, further comprising:
receiving an acceptance of the proposed thermostat configuration; and
transmitting, to a smart thermostat in the building, instructions to implement the proposed thermostat configuration.

15. The computer-implemented method of claim 13, further comprising:
receive a rejection of the proposed thermostat configuration;
identify, in response to receiving the rejection, a second proposed thermostat configuration; and
provide the second proposed thermostat configuration to the user device.

16. A system comprising:
one or more processors; and
at least one computer-readable storage medium having stored therein instructions which, when executed by the one or more processors, cause the system to:
receive, from a load forecast engine, a plurality of load forecasts associated with a thermostat set point schedule;
receive, from a user device, a change in the thermostat set point schedule;
generate a hybrid load forecast by selecting a portion of a first load forecast in the plurality of load forecasts and a portion of a second load forecast in the plurality of the load forecasts based on the change in the change in the thermostat set point schedule;
calculate a cost for the change in the thermostat set point schedule based on the hybrid load forecast and a fee schedule; and
provide the user device with the cost for the change in the thermostat set point schedule.

17. The system of claim 16, wherein the instructions further cause the system to transmit, to the load forecast engine, at least one of meter data, weather data, property data, interior condition data, or the thermostat set point schedule.

18. The system of claim 16, wherein the plurality of load forecasts associated with the thermostat set point schedule comprises a third load forecast associated with the thermostat set point schedule, and wherein the instructions further cause the system to:
calculate a cost for the thermostat set point schedule based on the third load forecast and the fee schedule; and
provide the user device with the cost for the thermostat set point schedule.

19. The system of claim 16, wherein the instructions further cause the system to:
generate a comparison between the cost for the thermostat set point schedule and the cost for the change in the thermostat set point schedule; and
provide the user device with the comparison.

20. The system of claim 16, wherein the thermostat set point schedule comprises a series of target temperature settings over time, and wherein the change in the thermostat set point schedule comprises at least one alteration, for at least one period of time, of a target temperature setting in the series of target temperature settings.
